(19) United States
(12) Patent Application Publication
(10) Pub. No.: US 2023/0092860 A1
(43) Pub. Date: Mar. 23, 2023

(54) PROTECTIVE MICROPHONE ENCLOSURE FOR AUTOMOTIVE EXTERIOR

(71) Applicant: MAGNA INTERNATIONAL INC., Aurora (CA)

(72) Inventors: Julian KNUTZEN, Toronto (CA); Daniel R. VANDER SLUIS, Rochester Hills, MI (US); Victoria Shkreli PACILLI, Windsor (CA); Parvinder S. WALIA, Shelby Township, MI (US); Oliver PACE, Clarkston, MI (US)

(21) Appl. No.: 17/948,537

(22) Filed: Sep. 20, 2022

Related U.S. Application Data
(60) Provisional application No. 63/246,085, filed on Sep. 20, 2021.

(51) Int. Cl. H04R 1/02; H04R 1/22

(52) U.S. Cl. CPC H04R 1/021; H04R 1/222; H04R 2201/003; H04R 2499/13

(57) ABSTRACT

A microphone enclosure for a vehicle exterior component includes a housing, and a microphone disposed within the housing. The housing also includes a first outer portion defining a sound channel for conveying sound to the microphone. The microphone enclosure includes a membrane of elastomeric material, such as silicone, disposed over the sound channel and configured to prevent contaminants, such as moisture and dust, from entering the sound channel. The sound channel has at least one dimension configured to provide a specific frequency response or acoustic sensitivity. A protective mesh may be disposed below the first membrane and configured to limit deflection of the first membrane. The housing includes an outer surface defining an aperture and a passageway providing auditory communication between the aperture and the microphone. In some embodiments, the passageway is configured as a tortuous path impeding straight-line access from the aperture to the membrane.

### CROSS-REFERENCE TO RELATED APPLICATIONS

This U.S. Utility Patent application claims the benefit of U.S. Provisional Patent Application Ser. No. 63/246,085 filed on Sep. 20, 2021 titled “Protective Microphone Enclosure For Automotive Exterior,” the entire disclosure of which is hereby incorporated by reference.

### BACKGROUND

This section provides background information related to the present disclosure which is not necessarily prior art.

Numerous systems exist and are being developed that use audio sensing in vehicular applications. Applications for such audio sensing systems include recognizing voice commands, for detecting emergency vehicles, etc. In some cases, it can be advantageous to include audio sensing around or on an exterior of a vehicle for detecting sounds outside of the vehicle. However, exterior-facing microphones present several design challenges, including resistance to weather and harsh operating conditions, such as wind, sunlight, high-pressure water from car wash systems, etc. Exterior-facing microphones must also be able to adequately detect sounds having specific frequencies in order to perform the associated sensing functions.

### SUMMARY

A microphone enclosure for a vehicle exterior component is provided. The microphone enclosure includes a housing and a microphone disposed within the housing. The housing includes an outer portion defining a sound channel for conveying sound to the microphone. The microphone enclosure also includes a membrane spaced apart from the microphone and configured to transmit sound to the microphone and to prevent contaminants from contacting the microphone. The sound channel has at least one dimension configured to provide a specific frequency response or acoustic sensitivity.

A microphone enclosure for a vehicle exterior component is provided. The microphone enclosure includes a housing and a microphone disposed within the housing. The housing includes an outer portion defining a sound channel for conveying sound to the microphone. The microphone enclosure also includes a membrane disposed over the sound channel and configured to prevent contaminants from entering the sound channel. The sound channel has at least one dimension configured to provide a specific frequency response or acoustic sensitivity.

### BRIEF DESCRIPTION OF THE DRAWINGS

Further details, features and advantages of designs of the invention result from the following description of embodiment examples in reference to the associated drawings.

FIG. 1 shows a schematic cross-sectional diagram of a first protective microphone enclosure in accordance with the present disclosure;

FIG. 2 shows a schematic cross-sectional diagram of a second protective microphone enclosure in accordance with the present disclosure;

FIG. 3A shows a first sound channel configuration of the first protective microphone enclosure of the present disclosure;

FIG. 3B shows a second sound channel configuration of the first protective microphone enclosure of the present disclosure;

FIG. 3C shows a third sound channel configuration of the first protective microphone enclosure of the present disclosure;

FIG. 3D shows a fourth sound channel configuration of the first protective microphone enclosure of the present disclosure;

FIG. 4 shows a graph illustrating frequency response functions for a first protective microphone enclosure with various different sound channel configurations;

FIG. 5 shows a schematic cross-sectional diagram of a third protective microphone enclosure in accordance with the present disclosure; and

FIG. 6 shows a schematic cross-sectional diagram of a fourth protective microphone enclosure in accordance with the present disclosure.

### DETAILED DESCRIPTION

Recurring features are marked with identical reference numerals in the figures, in which a first protective microphone enclosure 20 for a vehicle exterior component is disclosed. The vehicle exterior component may be, for example, a trim piece, a body panel, a mirror housing, etc. The first protective microphone enclosure 20 may provide durable environmental protection (e.g. protection from sunlight, moisture, dust, snow, ice, etc. to enable a vehicle to perform various auditory sensing functions, such as speech recognition, natural language processing (NLP) acoustic sensing, and/or other applications. The first protective microphone enclosure 20 may be configured to retain predetermined acceptable performance characteristics, and may be tunable to optimize acoustic performance for one or more particular applications.

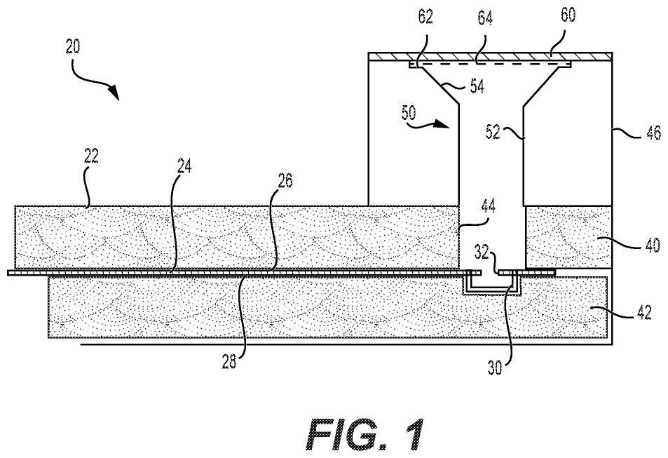

FIG. 1 shows a schematic cross-sectional diagram of the first protective microphone enclosure 20 that includes a housing 22, with a printed circuit board (PCB) 24 disposed therein. The PCB 24 is generally flat and defines a first face 26 and a second face 28 opposite the first face. The PCB 24 may be rigid or flexible. A microphone 30 is mounted to the PCB 24 and configured to convert sound energy to electrical signals that are transmitted to processing circuitry. The processing circuitry may be located on the PCB 24 or functionally connected thereto for receiving the electrical signals from the microphone 30. The processing circuitry may provide one or more functions, such as speech recognition, acoustic sensing, and/or other sound-related applications.

The microphone 30 may include a MEMS (micro-electromechanical system) device having both mechanical and electronic components. In some embodiments, and as shown in FIG. 1, the microphone 30 may be disposed on the second face 28 of the PCB 24 and configured to receive sound from the direction of the first face 26 of the PCB 24 via an aperture 32 in the PCB 24. The microphone 30 may be attached to one or both of the faces 26, 28 of the PCB 24. Alternatively or additionally, the microphone 30 may include one or more structures, such as pins, that pass through corresponding holes in the PCB 24.

The PCB 24 may be held within the housing 22 by an upper cushion 40 adjacent the first face 26 of the PCB 24 and a lower cushion 42 adjacent the second face 28 of the PCB 24. The upper cushion 40 may define a passage 44 adjacent the microphone 30 for transmitting sound therethrough. The cushions 40, 42 may be made of foam or other resilient material. The cushions 40, 42 may be compressed within the housing 22 to embed the PCB 24 and the microphone 30 to prevent acoustic coupling with any other air volumes, such as hollow portions of a vehicle component attached to the housing 22.

The first protective microphone enclosure 20 also includes a first outer portion 46 that defines a sound channel 50 overlying and in fluid communication with the passage 44 for conveying sound to the microphone 30. The sound channel 50 may have one of several different shapes and geometries, than may be adjusted or tuned for a particular application. For example, the shape and geometry of the sound channel 50 may be adjusted to set for sensitivity and frequency response of the first protective microphone enclosure 20. The example sound channel 50 shown in FIG. 1 has a tubular portion 52 and a flared portion 54 attached to the tubular portion, opposite of the microphone 30. The flared portion 54 expands (i.e. gets progressively larger) along a direction away from the microphone 30.

A first membrane 60 is disposed over the sound channel 50 to prevent contaminants, such as moisture and dust, from entering the sound channel 50 and contacting the microphone 30. The first membrane 60 is, therefore, configured as a protective cover to protect the microphone 30 from contaminants that could otherwise damage and/or interfere with operation of the microphone 30. The first membrane 60 may include a membrane of elastomeric material. For example, the first membrane 60 may include a thin diaphragm of material that includes silicone or is primarily or entirely made of silicone. However, other elastomeric materials may be used. The type of material or materials used in the first membrane 60 may depend on the requirements of a particular application, such as abrasion resistance, resistance to ultraviolet light, etc. In some embodiments, the first membrane 60 may include two or more layers. For example, the first membrane 60 may include a woven polymeric material such as PET or nylon with a coating of elastic material, such as polyurethane. The first membrane 60 may have an overall thickness of about 0.5 millimeters or thinner.

In some embodiments, and as shown in FIG. 1, the first protective microphone enclosure 20 also includes a step 62 slightly recessed below the first membrane 60 and configured to hold a protective mesh 64 below the first membrane 60 to limit deflection of the first membrane 60, thereby protecting the first membrane 60 from damage. For example, the protective mesh 64 may prevent the first membrane 60 from being damaged in misuse cases, such as being hit by a high-pressure water from a car wash nozzle. The protective mesh may be made of fine metal mesh, although other materials could be used.

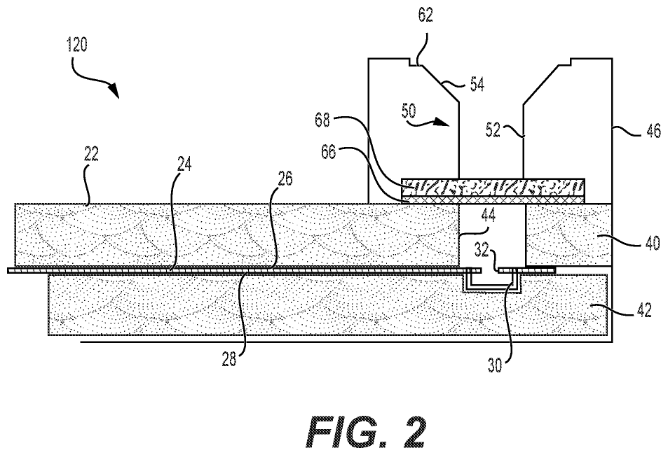

FIG. 2 shows a schematic cross-sectional diagram of a second protective microphone enclosure 120. The second protective microphone enclosure 120 may be similar or identical to the first protective microphone enclosure 20, except with the addition of a second membrane 66, 68 instead of the first membrane 60. As shown in FIG. 2, the second membrane 66, 68 is recessed within the sound channel 50 and separating the passage 44 of the housing 22 defining from the tubular portion 52 of the sound channel 50. The second membrane 66, 68 has a bi-layered construction including a first layer 66 and a second layer 68 overlying the first layer 66 and attached thereto. The first layer 66 may include a woven polymeric material such as PET or nylon. The second layer 68 may include a coating of elastic material, such as polyurethane. The second membrane 66, 68 may have an overall thickness of about 0.5 millimeters or thinner.

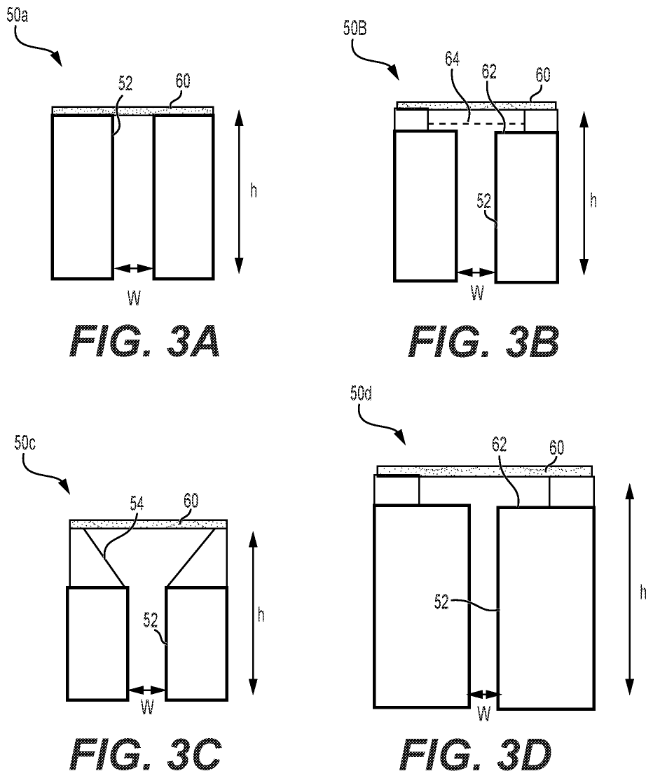

FIG. 3A shows a first sound channel configuration 50a, which may be used as the sound channel 50 in the first protective microphone enclosure 20 and/or the second protective microphone enclosure 120. The first sound channel configuration 50a includes only a tubular portion 52 that is directly covered by the first membrane 60. The tubular portion 52 defines a height h and a width w. In some embodiments, the tubular portion 52 may have a circular cross-section. In such cases, the width w may be referred to as a diameter. However, the tubular portion 52 may have other cross-sectional shapes, such as square, oval, rectangular, etc. The first sound channel configuration 50a does not include a protective mesh 64. In some embodiments, the height h may be 5.5 mm, and the width w may be 2.5 mm. However, either or both of the height h and the width w may have smaller or larger values, depending on a particular application.

FIG. 3B shows a second sound channel configuration 50b which may be used as the sound channel 50 in the first protective microphone enclosure 20 and/or the second protective microphone enclosure 120. The second sound channel configuration 50b is similar to the first sound channel configuration 50a, but with the addition of a step 62 around the tubular portion 52 and just below the first membrane 60, and with an addition of a protective mesh 64 upon the step 62, just below the first membrane 60. The second sound channel configuration 50b may define a height h, including both the tubular portion 52 and the height of the step 62, which may be 5.5 mm. The width w of the tubular portion 52 may be 2.5 mm. However, either or both of the height h and the width w may have smaller or larger values, depending on a particular application.

FIG. 3C shows a third sound channel configuration 50c which may be used as the sound channel 50 in the first protective microphone enclosure 20 and/or the second protective microphone enclosure 120. The third sound channel configuration 50c is similar to the configuration of FIG. 1, including the tubular portion 52 and the flared portion 54, but does not include the step 62 or the protective mesh 64. The third sound channel configuration 50c may define a height h, including both the tubular portion 52 and the flared portion 54, which may be 5.5 mm. The width w of the tubular portion 52 may be 2.5 mm. However, either or both of the height h and the width w may have smaller or larger values, depending on a particular application.

FIG. 3D shows a fourth sound channel configuration 50d which may be used which may be used as the sound channel 50 in the first protective microphone enclosure 20 and/or the second protective microphone enclosure 120. The fourth sound channel configuration 50d is similar to the second sound channel configuration 50b, but without the protective mesh 64. The fourth sound channel configuration 50d may define a height h, including both the tubular portion 52 and the height of the step 62, which may be 5.5 mm. The width w of the tubular portion 52 may be 1.5 mm. However, either or both of the height h and the width w may have smaller or larger values, depending on a particular application.

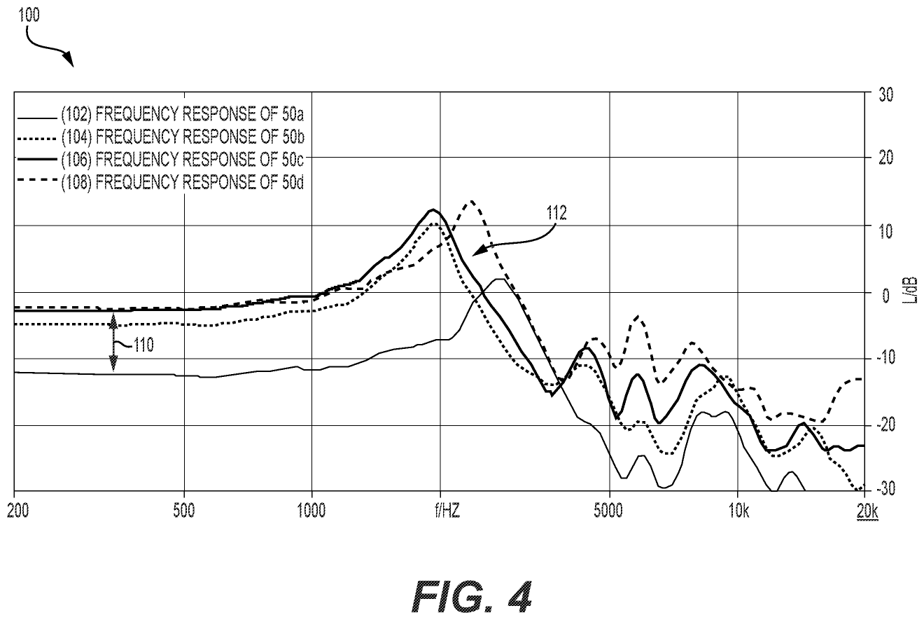

FIG. 4 shows a graph 100 illustrating frequency response functions for a first protective microphone enclosure 20 with various different sound channel configurations. Graph 100 includes a first plot 102 corresponding to the first sound channel configuration 50a. Graph 100 also includes a second plot 104 corresponding to the second sound channel configuration 50b. Graph 100 also includes a third plot 106 corresponding to the third sound channel configuration 50c. Graph 100 also includes a fourth plot 108 corresponding to the fourth sound channel configuration 50d.

The graph 100 includes a first region 110 at a low frequency of, for example, 300 Hz, where each of the plots 102, 104, 106, 108 are fairly straight, but with different gain levels, indicating that the gain or acoustic sensitivity can be set by the area of the diaphragm exposed to an external sound field. The graph 100 also includes a second region 112, at a higher-frequency of approximately 2000 Hz, where the plots 102, 104, 106, 108 diverge, indicating that the system acoustic resonance can be adjusted by relation of mass and stiffness of the diaphragm (i.e., the first membrane 60), and by the amount of air trapped in the enclosed volume of the sound channel 50, which can function as an air spring.

The geometry of the various parameters, including the height, width, volume, and shape of the sound channel 50, and the mass and stiffness of the first membrane 60 can each be adjusted to tune the system in a way that the frequency response allows a best possible signal quality for a particular application, such as for speech recognition or natural language processing, or for other applications like emergency vehicle detection, etc., while also providing a sufficient degree of environmental protection and resistance to damage over the vehicle lifetime.

In some embodiments, the resonance frequency as well as attenuation in combination with airtight silicone membrane can be tuned in a wide range. Addition of a protective mesh 64 of very fine metal mesh under the first membrane 60 silicone membrane to restrict deflection in misuse cases (e.g., direct spray with high-pressure nozzle) may provide minor to no influence on acoustic performance

Natural language processing (NLP) experiments indicate that frequency response/transfer function of silicone cover assemblies used for the first membrane 60 can be tuned into a direction where NLP performance is retained or even improved due to resonance/filter characteristics of the first protective microphone enclosure 20.

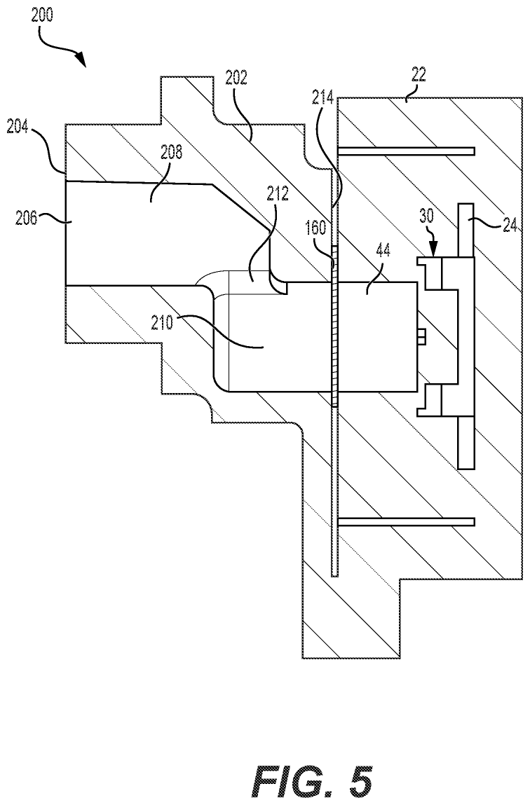

FIG. 5 shows a schematic cross-sectional diagram of a third protective microphone enclosure 200 that includes a housing 22 defining a passage 44 and with a microphone 30 disposed therein. The housing 22 and the microphone 30 may be similar or identical to corresponding devices and structures in the first protective microphone enclosure 20.

The third protective microphone enclosure 200 also includes a second outer portion 202 having a first outer surface 204 that defines a first aperture 206 providing communication to the microphone 30. The third protective microphone enclosure 200 also includes a third membrane 160 disposed between the housing 22 and the second outer portion 202. The third membrane 160 may be similar or identical to the first membrane 60 or the second membrane 66, 68. In some embodiments, and as shown in FIG. 5, the housing 22 and the second outer portion 202 have a unitary construction formed of a single piece of material. In some embodiments, and as shown in FIG. 5, the third protective microphone enclosure 200 includes a slot 214 between the housing 22 and the second outer portion 202, with the third membrane 160 disposed in the slot 214 and overlying the passage 44. The third membrane 160 may thereby protect the microphone 30 from damage due to contaminants such as moisture, dust, or dirt.

The second outer portion 202 also defines a first torturous passageway 208, 210, 212 having an S-shape for conveying sound to the microphone 30 while impeding straight-line access from the first aperture 206. The first torturous passageway 208, 210, 212 includes a first bore 208 that extends from the first aperture 206 part way through the outer second outer portion 202 toward the housing 22 and perpendicular to the first outer surface 204. The first bore 208 is formed as a blind hole that does not extend all the way through the second outer portion 202, and is spaced apart from the slot 214 by solid material. The first torturous passageway 208, 210, 212 also includes a second bore 210 that is offset from the first bore 208 and which extends in an opposite direction, from the slot 214 and aligned with the passage 44 in the housing 22, with the third membrane 160 disposed between the passage 44 and the second bore 210. The second bore 210 is formed as a blind hole that does not extend all the way through the second outer portion 202, and is spaced apart from the first outer surface 204 by solid material. The first torturous passageway 208, 210, 212 also includes a junction 212 where the first bore 208 at least partially intersects the second bore 210, providing fluid communication therebetween.

The first torturous passageway 208, 210, 212 may prevent the third membrane 160 from damage, such as penetration from sharp objects, strong water jets, etc. In some embodiments, one or more design parameters of the first torturous passageway 208, 210, 212, such as width, depth, and/or amount of overlap between the first bore 208 and the second bore 210 may be tuned for acoustic performance.

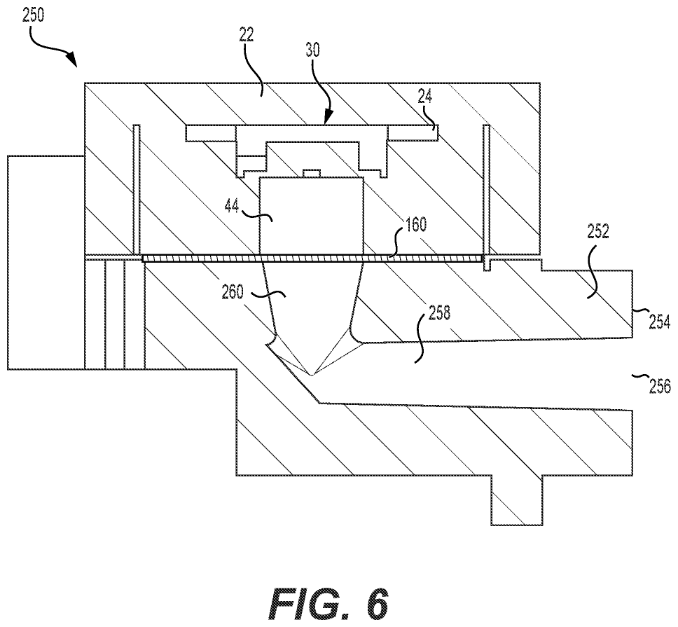

FIG. 6 shows a schematic cross-sectional diagram of a fourth protective microphone enclosure 250 that includes a housing 22 defining a passage 44 and with a microphone 30 disposed therein. The housing 22 and the microphone 30 may be similar or identical to corresponding devices and structures in the first protective microphone enclosure 20.

The fourth protective microphone enclosure 250 also includes a third outer portion 252 having a second outer surface 254 that defines a second aperture 256 providing communication to the microphone 30. The fourth protective microphone enclosure 250 also includes a third membrane 160 disposed between the housing 22 and the third outer portion 252. The third membrane 160 may be similar or identical to the first membrane 60 or the second membrane 66, 68. In some embodiments, and as shown in FIG. 6, the third membrane 160 is sandwiched between adjacent parallel faces of the housing 22 and the third outer portion 252 and overlying the passage 44. The third membrane 160 may thereby protect the microphone 30 from damage due to contaminants such as moisture, dust, or dirt.

The third outer portion 252 also defines a second torturous passageway 258, 260 for conveying sound to the microphone 30 while impeding straight-line access from the second aperture 256. The second torturous passageway 258, 260 includes a third bore 258 that extends from the second aperture 256 at least part way through the third outer portion 252 and perpendicular to the second outer surface 254. The third bore 258 is formed as a blind hole that does not extend all the way through the third outer portion 252. The second torturous passageway 258, 260 also includes a fourth bore 260 that intersects the third bore 258 and which extends toward the microphone 30. The fourth bore 260 is aligned with the passage 44 in the housing 22, with the third membrane 160 disposed between the passage 44 and the fourth bore 260. The fourth bore 260 is formed as a blind hole that does not extend all the way through the second outer portion 202. In some embodiments, the fourth bore 260 extends 90-degrees to the third bore 258. Alternatively, the third bore 258 and the fourth bore 260 may define an oblique angle, or an angle that is less than or greater than 90-degrees, and which still functions to impede straight-line access thereacross.

The second torturous passageway 258, 260 may prevent the third membrane 160 from damage, such as penetration from sharp objects, strong water jets, etc. In some embodiments, one or more design parameters of the second torturous passageway 258, 260, such as width, depth, and/or angle between the third bore 258 and the fourth bore 260 may be tuned for acoustic performance.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment (including all of the described embodiments), even if not specifically shown or described. The same may also be varied in many ways. Such variations are not to be regarded as a departure from the disclosure, and all such modifications are intended to be included within the scope of the disclosure.

What is claimed is:

1. A microphone enclosure for a vehicle exterior component, comprising:
a housing;
a microphone disposed within the housing;
wherein the housing includes an outer portion defining a sound channel for conveying sound to the microphone;
a membrane spaced apart from the microphone and configured to transmit sound to the microphone and to prevent contaminants from contacting the microphone; and
wherein the sound channel has at least one dimension configured to provide a specific frequency response or acoustic sensitivity.

2. The microphone enclosure as set forth in claim 1, wherein the microphone includes a micro-electromechanical system (MEMS) device.

3. The microphone enclosure as set forth in claim 1, wherein the membrane is disposed outside the sound channel, with the sound channel extending between the membrane and the microphone.

4. The microphone enclosure as set forth in claim 1, wherein the housing includes an outer surface defining an aperture, and a passageway providing auditory communication between the aperture and the microphone; and
wherein the membrane is disposed within the housing and recessed from the outer surface with the passageway extending between the outer surface and the membrane.

5. The microphone enclosure as set forth in claim 4, wherein the passageway is configured as a tortuous path impeding straight-line access from the aperture to the membrane.

6. The microphone enclosure as set forth in claim 5, wherein the passageway includes two bores that intersect one another at an oblique angle.

7. The microphone enclosure as set forth in claim 5, wherein the passageway includes two bores that intersect one another at a 90-degree angle.

8. The microphone enclosure as set forth in claim 5, wherein the passageway has an S-shape including two bores extending in opposite directions and overlapping at a junction.

9. The microphone enclosure as set forth in claim 8, wherein the two bores are parallel to one another.

10. The microphone enclosure as set forth in claim 1, wherein the membrane comprises silicone.

11. The microphone enclosure as set forth in claim 1, wherein the membrane has a bi-layer construction including a first layer and a second layer overlying the first layer and attached thereto, with an overall thickness of about 0.5 millimeters or thinner.

12. The microphone enclosure as set forth in claim 11, wherein the first layer comprises a woven polymeric material.

13. The microphone enclosure as set forth in claim 11, wherein the second layer comprises a coating of elastic material.

14. The microphone enclosure as set forth in claim 1, further comprising:
a printed circuit board (PCB) disposed with in the enclosure, with the microphone attached thereto; and
a cushion of resilient material compressed within the housing to embed the PCB and the microphone.

15. The microphone enclosure as set forth in claim 1, further comprising a protective mesh disposed below the membrane and configured to limit deflection of the membrane.

16. The microphone enclosure as set forth in claim 15, wherein the housing includes a step recessed below the membrane and configured to hold the protective mesh.

17. The microphone enclosure as set forth in claim 1, wherein the sound channel includes a tubular portion having a width and a height; and
wherein the at least one dimension configured to provide the specific frequency response or acoustic sensitivity includes the width and the height of the tubular portion.

18. A vehicle exterior component including the microphone enclosure as set forth in claim 1.

19. A vehicle-based system for natural language processing including the microphone enclosure as set forth in claim 1.

20. A microphone enclosure for a vehicle exterior component, comprising:
a housing;
a microphone disposed within the housing;
wherein the housing includes an outer portion defining a sound channel for conveying sound to the microphone;
a membrane disposed over the sound channel and configured to prevent contaminants from entering the sound channel; and
wherein the sound channel has at least one dimension configured to provide a specific frequency response or acoustic sensitivity.
